(19) United States
(12) Patent Application Publication
(10) Pub. No.: US 2014/0340920 A1
(43) Pub. Date: Nov. 20, 2014

(54) FLAT DEVICE FOR ILLUMINATING THE INTERIOR OF A VEHICLE

(71) Applicant: Lisa Dräxlmaier GmbH, Vilsbiburg (DE)

(72) Inventor: Bernhard BAYERSDORFER, Baierbach (DE)

(73) Assignee: Lisa Dräxlmaier GmbH, Vilsbiburg (DE)

(21) Appl. No.: 14/279,613

(22) Filed: May 16, 2014

(30) Foreign Application Priority Data
May 17, 2013 (DE) 10 2013 008 433.4

(51) Int. Cl. B60Q 3/00; F21V 8/00

(52) U.S. Cl. CPC B60Q 3/002; G02B 6/0093; G02B 6/0035
USPC 362/511

(57) ABSTRACT

The invention relates to a device for illuminating an assembly in the interior of a vehicle. The device comprises a flat light guide that is at least partially covered by an optical lacquer coat. The flat development of the light guide makes it easier to homogenously illuminate large faces. The optical lacquer coat protects the light guide in particular at the places where contamination must be feared or where a contact with additional assembly elements is planned. The optical lacquer coat has a defined refractive index and therefore controls the emergence of light rays at the surface of the light guide. An adhesive connects the lacquer coat to a cover element of spacer fabric and lining. This leads to a mechanically secure fastening of the light guide to the cover element that is to be backlit.

### CROSS-REFERENCE TO RELATED APPLICATIONS

This application is based upon and claims the benefit of prior German Application No. 10 2013 008 433.4, filed on May 17, 2013, the entire contents of which are incorporated herein by reference.

### TECHNICAL FIELD

The disclosure relates to a flat device for illuminating an assembly that is installed in the interior of a vehicle. Such devices are needed in particular in vehicles in the automotive field, in aviation, in rail-bound transport, and in shipping.

### BACKGROUND OF THE DISCLOSURE

DE 10 2012 215 801, for example, discloses illuminating an interior of a vehicle with a light guide. The light guide is used either to generate visible light lines or an indirect illumination, which is also referred to as ambient lighting. The illumination is intended at very specific places and should not have any fluctuations in brightness.

In such a light guide, the principle of the guiding of light is based on a reflection at a boundary between the light guide and surroundings. If the light guide has a refractive index of 1.5, for example, and is surrounded by air with a refractive index of 1.0, the total reflection occurs at the transition from an optically denser medium, i.e., the light guide, toward an optically thinner medium, in the present case the medium air.

However, when used in vehicles, light guides or contacts between the light guides and the surrounding materials may become contaminated, which has a negative effect on the luminous behavior. In particular, if light guides are used for backlighting assemblies, contacts to other materials, which are often connected by adhesives, can be avoided only at higher costs.

### SUMMARY

An object of the disclosed embodiments is to ensure a homogenous illumination of an assembly in an interior of a vehicle, which overcomes the disadvantages described above.

This problem is solved with a device having the characteristics consistent with embodiments of the disclosure.

The device according to the disclosure includes a flat light guide that is at least partially covered by an optical lacquer coat. Because of the flat development of the light guide, it is easier to homogenously illuminate larger areas. The optical lacquer coat protects the light guide in particular at the places where contamination may occur or where a contact to other assemblies is planned. The optical lacquer coat has a defined refractive index and therefore controls the emergence of light rays at the surface of the light guide.

Furthermore, the lacquer coat is at least partially connected to a first adhesive coat that establishes the contact to a cover element. This results in a mechanically secure fastening of the light guide to the cover element to be backlit, which barely raises the surface and can have any refractive indices. This means that conventional adhesives can be used for the cover element.

In some embodiments, the cover element includes a spacer fabric and a lining made of, e.g., leather, synthetic leather, or fabric, which are interconnected by a second adhesive coat. The spacer fabric results in a pleasantly soft haptic appearance of the cover element, onto which optically appealing and, if necessary, very thin linings can be applied with an additional adhesive. Because of the lacquer coat, selection of the materials of the cover element may not be limited, because they do not influence the optical reflection behavior. Alternately, the light guide can also be lined with a decorative sheet. In some embodiments, the decorative sheet is at least partially transparent. This can be achieved with the selection of material for the sheet or by printing color motives on a transparent sheet. Printing the sheet on both sides would create an additional depth effect. In some embodiments, the sheet is pulled down low, i.e., is produced by deep drawing, and therefore can be prepared for the form of the surface of the light guide, which also allows for three-dimensional flat interior equipment components. The sheet is glued to the lacquer coat that covers the light guide.

In some embodiments, the light guide is formed by injected molding or injection compression molding. These technologies allow for a simple and economic production of the flat light guide.

In some embodiments, the lacquer coat for a light guide made of polymethylmethacrylate (PMMA) has a refractive index of less than 1.49, and the lacquer coat for a light guide made of polycarbonate (PC) has a refractive index of less than 1.57. This means that PMMA and PC are two favorable light guide materials and there may be a sufficiently large selection of optical lacquers available.

In some embodiments, a thickness of the lacquer coat is greater than 1 μm to ensure a secure reflection, such as between 8 and 12 μm to compensate production tolerances. Lacquer coats that are too thick may be brittle.

According to the disclosure, the optical lacquer coat is essentially transparent, with an absorption spectrum independent of the wavelength in the visible spectral range (380-780 nm) so as not to effect any color changes of the radiated light.

In some embodiments, the lacquer coat has a damping independent of wavelength. This means that light effects that are not monochrome and support a multi-color illumination or an illumination that changes color can be used as well.

According to the disclosure, the light guide has a surface structure to evenly couple out light. This can achieve even large-area illuminations where a weakening of a luminous power is compensated over the length of the light guide and a largely homogenous luminous intensity can be achieved. In some embodiments, the surface structure includes a large number of dot-shaped notches. The notches are easy to apply and barely impact the mechanical strength of the light guide. In some embodiments, the dot-shaped notches increase in size starting at a coupling in spot so that the largest notches at the end of the light guide then couple out from the lesser luminous intensity a light quantity that is similar in size to that at the beginning of the light guide. Alternately to notches, scatter particles can be used as well to couple out light. For example, PMMA by Evonik, manufacturer's reference LD12, LD24, LD48, LD96, and/or “Endlighten” can be applied to the light guide. In the production of the light guide, structural elements such as stiffeners and hooks for later fastening can be already applied in the light guide. Such a one-piece development of the light guide simplifies the assembly of the interior equipment parts.

According to the disclosure, light-emitting diodes (LED) or laser diodes may be used to couple light into the light guide. In some embodiments, a plurality of LEDs are used. LED light is coupled into the light guide along an edge of the light guide over a large number of coupling spots. Single-color or RGB LED maybe used.

The device can be used in vehicle doors, cockpit, or central consoles where the optical effects are well visible to the driver without interfering with the view of the road.

In addition, the description of certain embodiments below reveals other advantages and characteristics of the disclosure. The characteristics described there can be implemented alone or in combination with one or more of the characteristics described above. Below, embodiments consistent with the disclosure will be described with reference to the drawings.

### BRIEF DESCRIPTION OF THE FIGURES

FIG. 1 shows a schematic top view of a flat light guide with a surface structure and coupling in spots.

FIG. 2 shows a schematic cross-sectional view of a device with a light guide and a cover part.

FIG. 3 shows a schematic representation of a coat structure of the device.

FIG. 4 shows a schematic representation of the interior of a vehicle with the illumination device installed.

FIG. 5 shows a schematic representation of an assembly with illumination.

FIG. 6 shows a schematic representation of an interior component with decorative sheet.

FIG. 7 shows a method for the production of the illumination device.

### DESCRIPTION OF THE EMBODIMENTS

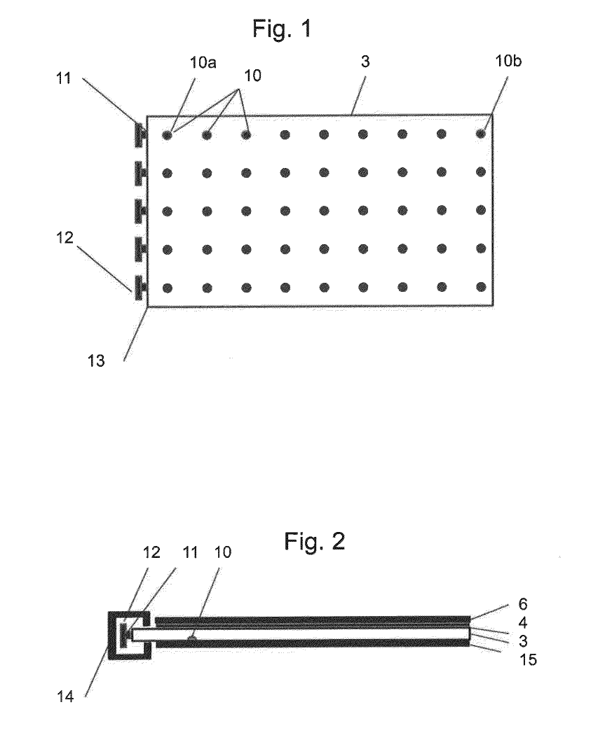

FIG. 1 shows a schematic representation of a flat light guide 3 for backlighting of a central part of a door having a size of 500 mm×200 mm. To couple in light, five light-emitting diodes (light diodes, LEDs) 12 are provided at an edge 13, which couple in light in changeable colors via the coupling-in spots 11. The specific number of LEDs 12 and coupling-in spots 11 depends on a width of the light guide 3, a desired maximum luminosity, and a luminosity of the individual LED 12, and can be dimensioned appropriately.

The light guide 3 is surface-treated to ensure that the light is coupled out of the light guide 3 evenly and in a directed fashion. In the direction of the coupling out of the light, the surface has notches 10 that are arranged in one line from the coupling-in location at the edge 13 at the start of the light guide 3 to the end of the light guide 3. In some embodiments, the first notch 10a has a smaller diameter than the last notch 10b. However, other means can be used here as well to adjust the relative portion of light coupled out from the total light passing the coupling-out spot, so that the portion of the light is small at the start of the light guide 3 and large at the end of the light guide 3.

FIG. 2 shows in a schematic representation a cross-section of the device with the light guide 3, into which light is coupled in via the coupling spot 11 and RGB LED 12 located in a housing 14. An optical lacquer coat 4 is applied over the entire surface of the light guide 3, and a cover element 6 is fastened onto said lacquer coat, On the side facing away from the cover element 6, i.e., opposite the direction of radiation of the light, the notch 10 is placed in such a fashion that a light quantity depending on the diameter of the notch 10 is coupled out and radiated in the direction of the cover element 6.

A reflection coat 15 is applied on the side opposite the light guide 3. At the notch 10 that forms the coupling-out spot, the reflection coat 15 reflects refractive light that refracts into the direction of the reflection coat 15 back to the side where the light is coupled out. Alternately, the reflection coat 15 can also be formed by an optical lacquer, with the reflection effect then being a lesser one.

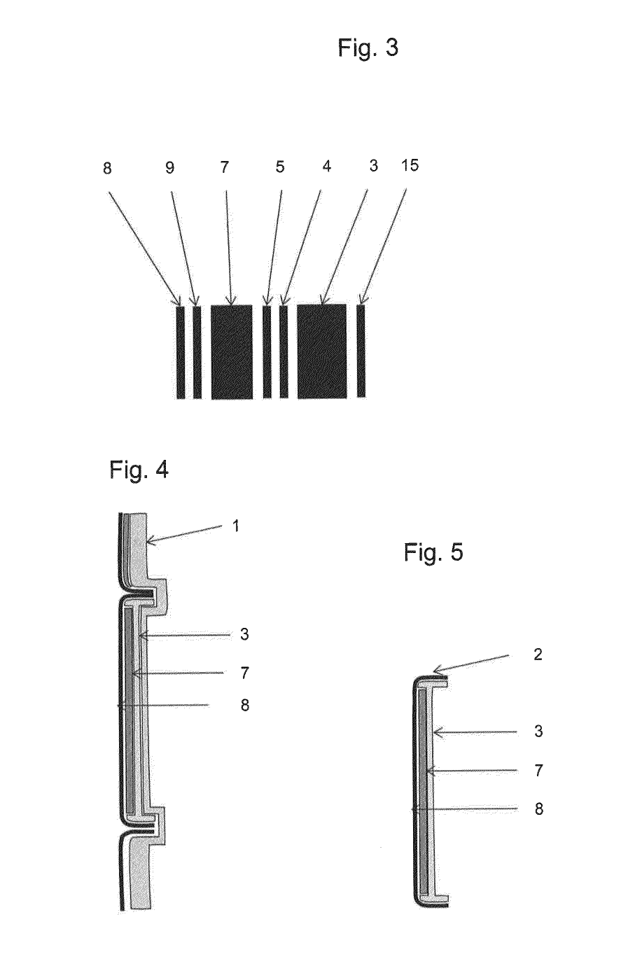

FIG. 3 shows a schematic representation of the coat structure of the device. It is noted that the spaces between the layers 8, 9, 7, 5, 4, 3, and 15 shown in FIG. 3 are for illustration purpose only, such that different layers are distinguished from each other. In the actual device, such spaces may not exist. The light guide 3 is covered by a reflection coat 15 on the side facing away from where the light is coupled out, whereas a lacquer coat 4 including an optical lacquer is applied on the side where the light is coupled out. A thickness of the light guide 3 is about 2 mm. Consistent with the disclosure, the lacquer coat 4 is at least 1 μm thick. In some embodiments, such as for process- and tolerance reasons, the lacquer 4 has coat thickness in a range of 8-12 μm, such as 10 μm.

A refractive index of the lacquer coat 4 is adjusted according to the light guide 3, and is smaller than a refractive index of a synthetic material that forms the light guide 3. For example, if polymethylmethacrylate PMMA is used to form the light guide 3, the refractive index of the lacquer coat 4 is less than 1.49. If polycarbonate PC with a refractive index of approximately 1.57 is used to form the light guide 3, the refractive index of the lacquer coat 4 is correspondingly smaller than the specific refractive number of the PC, i.e., is in a range up to 1.56.

The lacquer coat 4 may cover the light guide 3 on an entire surface area of the light guide 3, including narrow sides (which is not absolutely necessary), but not on the side of the reflection coat 15. However, if a reflection coat 15 is to be glued on as a sheet, this side can be lacquered as well. Alternately, the lacquer coat 4 covers only the places of the light guide 3 that are sensitive to soiling or need to fasten the cover element 6, which includes a spacer fabric 7 and a lining 8. The spacer fabric 7 has a thickness of a few millimeters to generate a soft, supple surface of the cover element 6. A structure without a spacer fabric 7, i.e., a hard lining, is also possible. The remaining coat thicknesses are substantially smaller.

The connection between the lacquer coat 4 and spacer fabric 7 is effected by a first adhesive coat 5. A second adhesive coat 9 connects the spacer fabric 7 and the lining coat 8. For a robust connection that avoids trapped air, the adhesive coats 5 and 9 are applied to nearly the entire surface of the coats 4, 7, and 8. A suitable adhesive includes Alexit-HighGloss-Clearcoat 460-13 by Mankiewicz.

FIG. 4 shows an interior 1 of a vehicle with the illumination device attached. The light guide 3 has a T-structure, with orthogonally projecting ends at the narrow sides of the light guide 3 for clamping it to the interior 1 to backlight the assembly 2 of a motor vehicle. Separated by lacquer coat and adhesive coat (both not shown), the spacer fabric 7 follows, which in turn is connected to the lining coat 8 by a second adhesive coat (not shown). The light guide 3 is slightly rounded off at the T-ends arranged at the narrow sides so that the lining coat 8 can enclose said ends and the device can be clipped into the interior 1 without the light guide 3 being visible. The assembly 2 is a central section of a door (see FIG. 5). The assembly 2 can be inserted into the door of the vehicle without additional tools. The light guide 3 is shown planar in FIGS. 4 and 5. However, it is also possible to generate contours desired for the form of the interior of the vehicle, e.g., the light guide 3 can be alternately curved stronger and form a three-dimensional face.

FIG. 5 shows the same device before it is introduced into the assembly 2. Toward the interior of the vehicle, the device is covered with the lining coat 8 of leather or fabric so that other materials are not visible. This creates an optically appealing surface. The surface area, which is haptically improved by the underlying spacer fabric 7, is furthermore soft and elastically supple. The device can be introduced later into the interior 1 easily and without great effort, thus making a retrofitting with a backlit cover element possible.

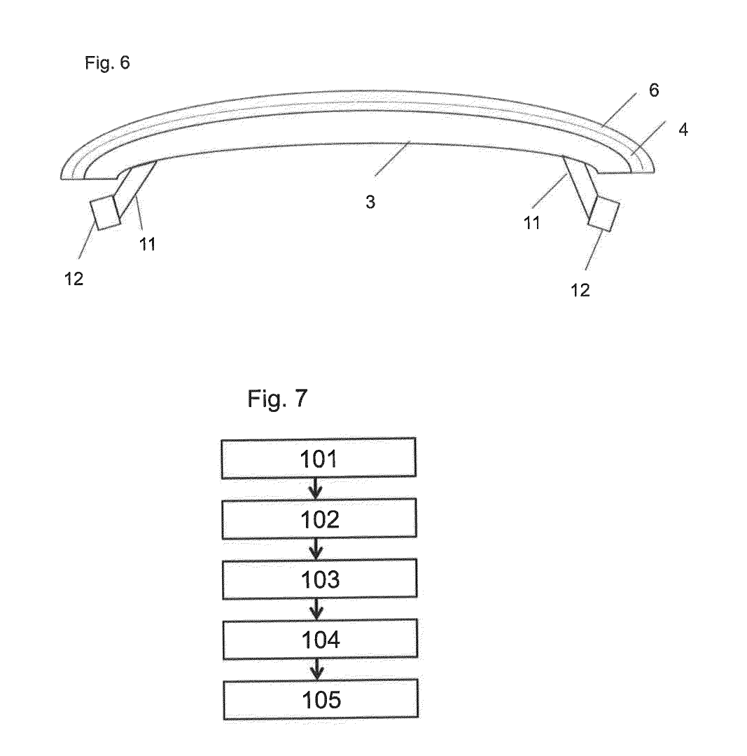

FIG. 6 shows another exemplary device consistent with embodiments of the disclosure. As shown in FIG. 6, the device includes a three-dimensional flat light guide 3 to which additional reinforcements and holding elements (not shown) are attached. The light is coupled in at two coupling spots 11, which are introduced as ramps into the surface area of the light guide 3 near the curvatures. At the coupling spots 11, respective RGB LED 12 are attached, which couple light into the light guide 3 at an angle that is in interaction with the optical lacquer coat 4 applied to the light guide lead to the reflection at the contact surface between light guide 3 and optical lacquer coat 4. A low-drawn, printed sheet 6 (i.e., the sheet 6 is produced by deep drawing), that is about 0.2 to 0.3 mm thick is glued onto the optical lacquer coat 4 and follows the form of the light guide 3. The sheet 6 includes a transparent polycarbonate PC or polymethylmethacrylate PMMA. It can also be up to 1 mm thick and it can also be imprinted on the side facing the optical lacquer coat 4, which creates a depth effect.

FIG. 7 shows a method for producing the illumination device consistent with embodiments of the disclosure. At 101, the flat light guide 3 is produced by means of injection molding or compressed injection molding. After it has dried out, the face of the light guide 3 is coated at 102 by spraying on an optical lacquer 4, which then dries. At 103, an adhesive 5 is sprayed onto the optical lacquer 4 and the spacer fabric 7 is applied. At 104, a second adhesive 9 is sprayed onto the spacer fabric 7 and leather is applied as lining coat 8. At 106, the LED 12 are plugged onto the coupling spots 11.

Other embodiments of the disclosure will be apparent to those skilled in the art from consideration of the specification and practice of the disclosed embodiments herein. It is intended that the specification and examples be considered as exemplary only, with a true scope and spirit of the disclosed embodiments being indicated by the following claims.

1-16. (canceled)

17. A device for illuminating an assembly of an interior of a vehicle, comprising:
a flat light guide having a first refractive index;
an optical lacquer coat at least partially covering the light guide and having a second refractive index smaller than the first refractive index;
an adhesive coat at least partially wetting the lacquer coat; and
a cover element connected to the lacquer coat by the adhesive coat.

18. The device according to claim 17, wherein:
the cover element includes:
a spacer fabric, and
a lining made of at least one of leather, synthetic leather, or fabric,
the adhesive coat is a first adhesive coat, and
the spacer fabric and lining are connected to each other by a second adhesive coat.

19. The device according to claim 17, wherein the cover element includes a sheet that is produced by deep drawing and imprinted.

20. The device according to claim 17, wherein the light guide includes an injection molded light guide or an injection compression molded light guide.

21. The device according to claim 17, wherein:
the light guide includes polymethylmethacrylate, and
the second refractive index is less than 1.49.

22. The device according to claim 17, wherein:
the light guide includes polycarbonate, and
the second refractive index is less than 1.57.

23. The device according to claim 17, wherein the lacquer coat has a thickness larger than 1 μm.

24. The device according to claim 23, wherein the thickness of the lacquer coat is between 8 and 12 μm.

25. The device according to claim 17, wherein the lacquer coat is essentially transparent in a visible spectral range.

26. The device according to claim 17, wherein the lacquer coat has a damping that is independent of wavelength.

27. The device according to claim 17, wherein the light guide includes a surface structure configured to evenly couple out light.

28. The device according to claim 27, wherein the surface structure includes a plurality of dot-shaped notches or scatter particles.

29. The device according to claim 28, further comprising:
a coupling-in spot configured to couple light into the flat light guide.

30. The device according to claim 29, wherein the surface structure includes the plurality of dot-shaped notches that increase in size away from the coupling-in spot.

31. The device according to claim 17, further comprising:
a light-emitting diode.

32. The device according to claim 17, further comprising:
a plurality of coupling-in spots affixed along an edge of the light guide; and
a plurality of light-emitting diodes respectively coupled with the coupling-in spots.

33. The device according to claim 17, wherein the light guide is curved and forms a three-dimensional face that specifies a contour of the interior of the vehicle.

34. The device according to claim 17, wherein the interior includes at least one of a vehicle door, a cockpit, or a central console.
